(19) United States
(12) Patent Application Publication
(10) Pub. No.: US 2026/0273906 A1
(43) Pub. Date: Sep. 17, 2026

(54) OVERMOLDED COMPOSITE STRUCTURE

(71) Applicant: ARKEMA FRANCE, Puteaux (FR)

(72) Inventors: Thibaut SAVART, Lacq (FR); Karine LOYEN, Serquigny (FR); Sébastien MOUGNIER, Serquigny (FR); Benjamin SAILLARD, Serquigny (FR); Marc MIRALLES, Serquigny (FR)

(73) Assignee: ARKEMA FRANCE, Puteaux (FR)

(21) Appl. No.: 19/167,247

(22) PCT Filed: Mar. 20, 2024
(86) PCT No.: PCT/FR2024/050336

§ 371 Date: Sep. 19, 2025

(30) Foreign Application Priority Data
Mar. 20, 2023 (FR) FR2302561

(51) Int. Cl. B32B 27/34; B32B 5/02; B32B 27/12; C08J 5/24

(52) U.S. Cl. CPC B32B 27/34; B32B 5/02; B32B 27/12; C08J 5/243; B32B 2250/02; C08J 2377/02

(57) ABSTRACT

The invention relates to an overmolded composite structure comprising: i) a first component C1 comprising at least one fibrous material and a matrix resin composition, said matrix resin composition comprising at least one reactive thermoplastic polymer, and optionally a chain extender or chain limiter, said thermoplastic polymer having a number-average molecular weight Mn between 3,000 and 35,000 g/mol, preferably between 5,000 and 20,000 g/mol, preferably between 5,000 and 15,000 g/mol, preferably between 5,000 and 10,000 g/mol; and ii) a second component C2 comprising an overmolding resin composition, the first component C1 having at least one surface S, and component C2 adhering to component C1 on at least part of surface S.

### FIELD OF THE INVENTION

The present invention relates to an overmolded structure comprising a composite and an overmolded thermoplastic polymer component.

### TECHNICAL BACKGROUND

Composite materials are increasingly being developed in various fields such as automotive, aeronautics, sports equipment, etc. Hybrid structures (composite/metal, composite/polymer, or metal/polymer, etc.) are being developed and are also seen as an interesting alternative not only to lighten and strengthen structures but also to provide multiple functions to the manufactured part. There is notably, a desire to replace the metallic parts of certain pieces to reduce the weight of said pieces and reduce production costs. Such composites are notably used for the manufacture of overmolded composite structures where a component is overmolded on at least a part of a surface of the composite.

Thus, many players in the automotive and aeronautics fields have developed methods for manufacturing improved parts.

For example, localized reinforcements based on composites (carbon fibers+thermoplastic polymer) are placed in an injection mold of an automotive part to locally and intelligently reinforce the injected part (car door, for example). Thus, the part is lightened and reinforced in its preferred direction(s) of stress.

In addition to these areas of use, other players in high-tech and performance fields have sought to appropriate these new transformation technologies and adapt them to their needs.

Thus, for several years, there have been numerous developments in sport, leisure and electronics. For example, more, and more manufacturers of running or athletics shoes, as well as bicycles and other competitive or leisure sports, include composite reinforcement elements in their shoes. These composites allow to provide improved and diverse performance to their product, such as better durability, higher performance (notably energy return), and weight reduction, for example.

These composites generally present in the form of plates that are manufactured in advance by traditional processes and are generally based on carbon fibers impregnated with thermosetting resins (epoxies) or, in rare cases, thermoplastic (acrylics, PC, PP). These composite reinforcements can then be integrated into finished products according to different methods, notably bonding to an existing support. This bonding is essential and ensures cohesion between the composite part and the overmolded polymer/elastomer, which are generally not of the same chemical nature. It also allows to maintain the composite in place for the subsequent stages of finished product manufacturing. Without cohesion, the composite and the overmolded product will have limited performance over time and/or will not meet certain essential performance criteria right out of the production line (dimensions and positioning in the finished product, finish appearance, optical quality, thermal or electrical conductivity/insulation, mechanical load transfer from the overmolded to the composite and vice versa, premature interface failure, etc.)

Bonding solutions, to be most compatible with the elements to be assembled, are generally based on reactive thermosetting resins (cold or hot) and/or solvent-based. They are therefore not perfectly compatible with the two components of the overmolded composite if they are of different chemical nature. They are also not depolymerizable in a possible dismantling and recycling phase of the product at the end of its life.

To overcome these inconveniences, alternative solutions have been proposed:
preparing the surface state of the composites to make them rougher/more textured. Thus, the specific contact surface is larger and therefore potentially of better quality between the composite and the adhesive. However, there remains a chemical/physical incompatibility that limits performance and/or the duration of use while maintaining performance.
using thermoplastic adhesives instead of thermosetting adhesives. However, the application of these adhesives is often more complicated, and very generally, it is only compatible with one of the two components to be assembled.
surface treatment to functionalize one or both surfaces to better compatibilize them. However, this step, which generally consists of a plasma treatment (cold or hot), is costly, and the surface treatment has a short lifespan (a few hours at best).

It is known from US2012108122 of overmolded composite structures not requiring the use of adhesive. However, before the overmolding step, the composite is heated close to its melting temperature, which can damage the physical properties of the composite, notably its degree of consolidation influencing the mechanical performance of the final piece.

There is therefore a real need to provide a composite material compatible with the overmolding polymer layer, allowing to dispense with any additional adhesion primer between the composite and the overmolded component. There is also a real need to provide a composite material compatible with the overmolding polymer layer and allowing good adhesion between the composite material and the overmolding layer, notably allowing to obtain a peel strength greater than 50N/cm, preferably greater than or equal to 70 N/cm, and particularly preferred greater than or equal to 100 N/cm.

### SUMMARY OF THE INVENTION

The invention relates primarily to an overmolded composite structure comprising:
i) a first component (C1) comprising at least one fibrous material and a matrix resin composition, said matrix resin composition comprising at least one reactive thermoplastic polymer, and possibly a chain extender and/or chain limiter and/or catalyst and/or one or more additives, said thermoplastic polymer presents a number average molecular weight Mn between 3,000 and 35,000 g/mol, preferably between 5,000 and 20,000 g/mol, preferably between 5,000 and 15,000 g/mol, more preferably between 5,000 and 10,000 g/mol; and
ii) a second component (C2) comprising an overmolding resin composition, the said first component (C1) comprising at least one surface(S) and said component C2 adhering to said component (C1) on at least one part of the surface(S).

Preferably, said at least one reactive thermoplastic polymer is a polyamide, polycarbonate, or polymethacrylate, preferably polyamide, and may include epoxy-type groups, preferably said reactive thermoplastic polymer is a polyamide.

Preferably, said at least one reactive thermoplastic polymer is chosen from among:
an aliphatic polyamide chosen from among the polyamide 6 (PA-6), the polyamide 11 (PA-11), the polyamide 12 (PA-12), the polyamide 66 (PA-66), the polyamide 46 (PA-46), the polyamide 610 (PA-610), the polyamide 612 (PA-612), the polyamide 1010 (PA-1010), the polyamide 1012 (PA-1012), the polyamide 11/1010, and the polyamide 12/1010, or a mixture thereof or a copolyamide thereof, and poly ether amide or poly ether ester amide copolymers (PEBA) (or copolymer of polyamide block and polyether block), or
a semi-aromatic polyamide is a semi-aromatic polyamide, possibly modified by urea units, notably a PA MXD6 and a PA MXD10 or a semi-aromatic polyamide of formula A/XT in which A is chosen from among a motif obtained from at least one amino acid, a motif obtained from at least one lactam, and at least one motif corresponding to the formula (diamine in Ca). (diacid in Cb), with a representing the number of carbon atoms of the diamine and b representing the number of carbon atoms of the diacid, a and b each being between 4 and 36, advantageously between 9 and 18, the motif (diamine in Ca) being chosen from among linear or branched aliphatic diamines, cycloaliphatic diamines, and alkylaromatic diamines, and the motif (diacid in Cb) being chosen from among linear or branched aliphatic diacids, cycloaliphatic diacids, and aromatic diacids; X·T designates a motif obtained from the polycondensation of a diamine in Cx and terephthalic acid, with x representing the number of carbon atoms of the diamine in Cx, x being between 6 and 36, advantageously between 9 and 18, notably a polyamide of formula A/6T, A/9T, A/10T, or A/11T, A being such as defined above, in particular a polyamide PA 6/6T, a PA 66/6T, a PA 61/6T, a PA MPMDT/6T, a PA PA11/10T, a PA 11/6T/10T, a PA MXDT/10T, a PA MPMDT/10T, a PA BACT/10T, a PA BACT/6T, a PA 11/BACT, a PA BACT/10T/6T, a PA 11/BACT/10T, T corresponds to terephthalic acid, MXD corresponds to m-xylylene diamine, MPMD corresponds to methylpentamethylene diamine, and BAC corresponds to 1,3-bis(aminomethyl)cyclohexane.

Preferably, the at least one reactive thermoplastic polymer is chosen from among:
an aliphatic polyamide chosen from among the polyamide 11 (PA-11), the polyamide 12 (PA-12), the polyamide 66 (PA-66), the polyamide 46 (PA-46), the polyamide 610 (PA-610), the polyamide 612 (PA-612), the polyamide 1010 (PA-1010), the polyamide 1012 (PA-1012), the polyamide 11/1010, and the polyamide 12/1010, or a mixture thereof or a copolyamide thereof, and the polyetheramide or the polyetheresteramide copolymers (PEBA) (or copolymer of polyamide block and polyether block), or
a semi-aromatic polyamide, possibly modified by urea units, notably a PA MXD6 and a PA MXD10 or a semi-aromatic polyamide of formula A/XT wherein A is chosen from among a motif obtained from at least one amino acid, a motif obtained from at least one lactam, and at least one motif corresponding to the formula (diamine in Ca). (diacid in Cb), with a representing the number of carbon atoms of the diamine and b representing the number of carbon atoms of the diacid, a and b each being between 4 and 36, advantageously between 9 and 18, the motif (diamine in Ca) being chosen from among linear or branched aliphatic diamines, the cycloaliphatic diamines, and the alkyl aromatic diamines, and the motif (diacid in Cb) being chosen from among the linear or branched aliphatic diacids, the cycloaliphatic diacids, and the aromatic diacids; X·T designates a motif obtained from the polycondensation of a diamine in Cx and the terephthalic acid, with x representing the number of carbon atoms of the diamine in Cx, x being between 6 and 36, advantageously between 9 and 18, notably a polyamide of formula A/6T, A/9T, A/10T, or A/11T, A being such as defined above, in particular a polyamide PA 6/6T, a PA 66/6T, a PA 61/6T, a PA MPMDT/6T, a PA PA11/10T, a PA 11/6T/10T, a PA MXDT/10T, a PA MPMDT/10T, a PA BACT/10T, a PA BACT/6T, a PA 11/BACT, a PA BACT/10T/6T, a PA 11/BACT/10T; T corresponds to terephthalic acid, MXD corresponds to m-xylylene diamine, MPMD corresponds to methylpentamethylene diamine, and BAC corresponds to 1,3-bis(aminomethyl)cyclohexane.

Preferably, the reactive thermoplastic polymer is a semi-aromatic polyamide chosen from among a PA MPMDT/6T, a PA PA11/10T, a PA 11/BACT, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/10T, a PA 11/BACT/10T, a PA 11/MXDT/10T.

Preferably, the reactive thermoplastic polymer is PA11 or PA12, preferably PA11.

Preferably, the overmolded resin composition is identical to, or different from the matrix resin, preferably it comprises an aliphatic polyamide polymer, or a semi-aromatic polymer as defined above.

Preferably, the fibrous material comprises fibers chosen from among:
mineral origin fibers such as carbon fibers, glass fibers, silicon carbide fibers, basalt fibers, silica fibers;
vegetable origin fibers, particularly fibers based on flax, hemp, lignin, bamboo, silk, notably spider silk or sisal, cellulosic fibers, particularly viscose;
organic origin fibers such as amorphous thermoplastic fibers with a glass transition temperature Tg higher than the Tg of the polymer of the matrix resin composition when the latter is amorphous or higher than the Tf of the polymer of the matrix resin composition when the latter is semi-crystalline and the Tg of which (in the case of an amorphous) or Tf (in the case of a semi-crystalline) is higher than the injection temperature of the overmolding resin composition, or semi-crystalline thermoplastic fibers with a fusion temperature Tf higher than the Tg of the polymer of the matrix resin composition when the latter is amorphous or higher than the Tf of the polymer of the matrix resin composition and the Tg of which (in the case of an amorphous) or the Tf (in the case of a semi-crystalline) is higher than the injection temperature of the overmolding resin composition, or a mixture of two or more of the said fibers, preferably a mixture of carbon, glass, or silicon carbide fibers, in particular carbon fibers
or their mixtures.

Preferably, the overmolded composite structure does not comprise an adhesion primer between the components C1 and C2.

Preferably, the matrix resin composition does not comprise a filler or comprises less than 2% by weight of filler, preferably from 0.01 to 0.5% by weight of filler relative to the weight of the matrix resin composition.

Preferably, the reactive thermoplastic polymer presents a melt viscosity measured in capillary rheology at a shear of 1800 s⁻¹ between 0.05 and 1000 Pa·s, preferably between 0.1 and 1000 Pa·s, preferably between 0.3 and 1000 Pa·s, preferably between 0.3 and 500 Pa·s, more preferably between 0.3 and 250 Pa·s, for example between 0.3 and 100 Pa·s, even more preferably between 0.3 and 50 Pa·s, more preferably between 0.3 and 25 Pa·s, even more preferably between 0.3 and 10 Pa·s, preferably between 0.3 and 5 Pa·s.

Preferably, the reactive thermoplastic polymer is an amorphous polyamide or a semi-crystalline polyamide presenting an absolute value of fusion enthalpy in the component (C1) before overmolding less than 12 J/g of matrix resin, preferably less than 8 J/g of matrix resin, preferably less than 5 J/g of matrix resin, calculated according to the equation (1).

$$\vert \underline{Fusion enthalph in component ( C 1 )} \vert = \underline{area under melting peak - area under crystallization peak} \qquad Equation ( 1 )$$

the measurement of enthalpy being performed by differential scanning calorimetry (DSC) according to the ISO 11357-3 standard of 2013, the melting and crystallization peaks being the first heating peaks at a rate of 20 K/min.

Preferably:
the matrix resin comprises an aliphatic polyamide, preferably PA11 or PA12, preferably PA11, and the overmolding resin a PEBA; or
the matrix resin comprises an aliphatic polyamide, preferably PA11 or PA12, preferably PA11, and the overmolding resin an aliphatic polyamide, preferably PA11 or PA12, preferably PA11; or
the matrix resin comprises an aliphatic polyamide, preferably PA11 or PA12, preferably PA11, and the overmolding resin a semi-aromatic polyamide; or
the matrix resin comprises a semi-aromatic polyamide and the overmolding resin an aliphatic polyamide, preferably PA11 or PA12, preferably PA11.

The present invention also relates to a method for manufacturing an overmolded composite structure according to the invention, comprising a step of overmolding the component C2 on at least part of the surface S of the component C1.

Preferably, the overmolding step is an injection overmolding step.

The present application also relates to the use of overmolded composite structures according to the invention for the manufacture of parts, notably in the fields of mechanics, aeronautics, nautical, automotive, oil and gas (particularly offshore, gas storage), energy, health and medical, sports and leisure, and electronics.

The present application also relates to the use of a matrix resin composition according to the invention, for the preparation of an overmolded composite structure comprising a first component (C1), comprising at least one fibrous material and said matrix resin composition; and a second component (C2), comprising an overmolding resin composition, to obtain a peel strength measured according to a suitable protocol of ISO 4578:1997 (90° peel) greater than or equal to 50N/cm, preferably greater than or equal to 70 N/cm, and particularly preferred greater than or equal to 100 N/cm between the component (C1) and the component (C2).

### DESCRIPTION OF FIGURES

FIG. 1 is a DSC thermogram of a component C1 according to the invention obtained with a matrix resin comprising a semi-aromatic polyamide. This graph corresponds to the first heating of the DSC analysis program and shows the area (A) under the first heating peak corresponding to the first heating crystallization peak and the area (B) under the first heating peak corresponding to the first heating melting peak. The enthalpy measurement is performed by differential scanning calorimetry (DSC) according to ISO 11357-3 of 2013, with the melting and crystallization peaks being the first heating peaks at a speed of 20 K/min.

FIG. 2 is a representative diagram of the test specimens prepared in example 2.

### DETAILED DESCRIPTION

The invention is now described in more detail and in a non-limiting manner in the following description.

Unless otherwise indicated, all percentages are by mass.

In the present text, the quantities indicated for a given species may apply to that species according to all its definitions (such as mentioned in this text), including more restricted definitions.

In the present description, “fibrous material” means a set of unitary reinforcing fibers.

By thermoplastic, or thermoplastic polymer, is meant a material generally solid at room temperature, which can be semi-crystalline or amorphous, and which softens when the temperature increases, in particular after passing its glass transition temperature (Tg) and flows at a higher temperature when it is amorphous, or can present a clear melting upon passing its so-called melting temperature (Tf) when it is semi-crystalline, and which becomes solid again when the temperature decreases below its crystallization temperature (for a semi-crystalline) and below its glass transition temperature (for an amorphous).

The Tg and Tf are determined by differential scanning calorimetry (DSC) according to ISO 11357-2:2013 and 11357-3:2013 respectively.

### Overmolded Composite Structure

The invention primarily relates to an overmolded composite structure comprising:
i) a first component (C1) comprising at least one fibrous material and a matrix resin composition, said matrix resin composition comprising at least one reactive thermoplastic polymer, and possibly, a chain extender and/or chain limiter and/or catalyst and/or one or more additives, said thermoplastic polymer presenting a number average molecular weight Mn between 3,000 and 35,000 g/mol, preferably between 5,000 and 20,000 g/mol, preferably between 5,000 and 15,000 g/mol, preferably between 5,000 and 10,000 g/mol; and
ii) a second component (C2) comprising an overmolding resin composition,
the said first component (C1) comprising at least one surface(S) and the said component (C2) adhering to the said component (C1) on at least one part of the said surface (S).

It should be understood that the first component (C1) can be of any shape, 2D or 3D, and notably can be in the shape of a parallelepiped, or a more complex 2D or 3D shape and can therefore comprise several surfaces(S). The component (C2) adheres to the said component (C1) on at least one of its surfaces(S). The invention also covers the case where the component (C2) adheres to the said component (C1) on several distinct surfaces(S), the said component (C2) being able to be identical or different according to the surfaces(S).

In a particular advantageous manner, the inventors have shown that the specific choice of the matrix resin composition allows to obtain good cohesion between the components (C1) and (C2) and notably good adhesion (or “cohesion”) without requiring the use of an adhesion primer between the components (C1) and (C2). In a particularly advantageous manner, the inventors have shown that the specific choice of the matrix resin composition allows to obtain good adhesion between the components (C1) and (C2), characterized by a peel strength, measured according to a suitable protocol of ISO 4578:1997 (90° peel) greater than or equal to 50N/cm, preferably greater than or equal to 70 N/cm and particularly preferred greater than or equal to 100 N/cm.

Overmolding consists of molding a product (here the component (C1)). It should be understood that an overmolded composite structure is different from an association of two impregnated fibrous materials. The overmolding resin composition, unlike impregnated fibrous materials, cannot comprise continuous fibers. Indeed, the presence of continuous fibers would make it unusable in overmolding processes, for example in injection overmolding processes.

Overmolding consists of molding, in a mold containing the prefabricated component (C1), the second component (C2) which is introduced at a temperature higher than the glass transition temperature of the component (C2) if said component (C2) comprises an amorphous polymer or higher than the melting temperature of the component (C2) if said component (C2) comprises a semi-crystalline polymer.

### Matrix Resin Composition

The term “reactive thermoplastic polymer” means that said thermoplastic polymer is likely to react with the overmolding resin or possibly with itself by condensation with release of water or by substitution or by reaction with a chain extender by polyaddition or polycondensation. In a particularly advantageous manner, the said polymer can react with the overmolding resin by means of its terminal functionalities, or even by exchange reaction between their respective repeating units, or even by reaction between their repeating units and their terminal functionalities. Optionally, this reaction is made possible by the addition of additives.

When this “reactive thermoplastic polymer” reacts with itself, it presents an initial number average molecular weight Mn1 and an initial melt viscosity n1. When its temperature is greater than its glass transition temperature, in particular, greater than its melting temperature, this mass evolves by reaction with itself, which means that the number average molecular weight Mn2 and the melt viscosity n2 of the polymer resulting from the reaction of the reactive thermoplastic polymer with itself are greater than or equal to the initial molecular weight Mn1 and the initial melt viscosity n1. Preferably, Mn2 is greater than Mn1 by at least 5%, preferably by at least 10%.

In the following, we will refer to the number average molecular weight of the reactive thermoplastic polymer as the number average molecular weight of the thermoplastic polymer if it has not reacted with itself or that of the polymer resulting from its reaction with itself (Mn2). Similarly, in the following, we will refer to the melt viscosity as the viscosity of the thermoplastic polymer if it has not reacted with itself or that of the polymer resulting from its reaction with itself (n2).

Chain extenders can be any type of chain extender known to those skilled in the art, as for example those cited in patent application FR1907685.

These number average molecular weights are understood to be in the solid state after cooling of the polymer.

Preferably, the reactive thermoplastic polymer is a polyamide, polycarbonate, or polymethacrylate, preferably polyamide. Optionally, it includes epoxy-type functional groups.

Preferably, the reactive polymer is a polyamide, notably an aliphatic, cycloaliphatic, or semi-aromatic polyamide.

Advantageously, the reactive thermoplastic polymer is a homopolyamide or a copolyamide or a mixture thereof.

The number average molecular weight Mn of said reactive thermoplastic polymer is between 3,000 and 35,000 g/mol, preferably between 5,000 and 20,000 g/mol, preferably between 5,000 and 15,000 g/mol, more preferably between 5,000 and 10,000 g/mol. This number average molecular weight can be determined, in particular, by size exclusion chromatography measurement according to ISO 16014-1:2012, 16014-2:2012, and 16014-3 standards using the following conditions:
Device: Waters Alliance 2695 instrument
Solvent: hexafluoroisopropanol stabilized with 0.05M potassium trifluoroacetate
Flow rate: 1 ml/minute
Column temperature: 40° C.
Two columns in series: 1000 Å PFG and 100 Å PFG (PPS)
Sample concentration: 1 g/L (dissolution at room temperature for 24 h)
Sample filtration using a syringe equipped with an ACRODISC PTFE filter diameter 25 mm porosity 0.2 μm
Injection volume: 100 μl
Refractive index detection at 40° C. with UV detection at 228 nm
Calibration by PMMA standards from 1,900,000 to 402 g/mol. Calibration curve modeled by a fifth-degree polynomial.

Advantageously, the composite obtained with such a matrix allows more improved adhesion with the overmolding matrix to be obtained, notably resulting in an even greater peel strength.

Preferably, the said at least one reactive thermoplastic polymer presents a melt viscosity measured in capillary rheology at a shear of 1800 s⁻¹ between 0.05 and 1000 Pa·s, preferably between 0.1 and 1000 Pa·s, preferably between 0.3 and 1000 Pa·s, preferably between 0.3 and 500 Pa·s, more preferably between 0.3 and 250 Pa·s, for example between 0.3 and 100 Pa·s, even more preferably between 0.3 and 50 Pa·s, more preferably between 0.3 and 25 Pa·s, even more preferably between 0.3 and 10 Pa·s, preferably between 0.3 and 5 Pa·s. The melt viscosity is measured by capillary rheology using a Gottfert Rheotester 2000 device. The measurement temperature (T) follows the inequality Tf<T≤Tf+70° C. The measurement is made according to ISO 11443:2014. The preheating time is 240 seconds, the die presents a diameter of 1 mm and a length of 30 mm. The shear and viscosity are corrected by Rabinowitsch. Preferably, the melt viscosity is preferably measured at Tf+50° C., Tf being the melting temperature of the at least one polyamide. In an advantageous manner, the composite obtained with such a matrix allows even more improved adhesion with the overmolding matrix to be obtained, notably resulting in an even greater peel strength.

The reactive thermoplastic polymer constituting the matrix resin of the fibrous material can be constituted of a mixture of thermoplastic polymers of which at least one is reactive. This polymer or polymer mixture can be ground into powder form, in order to be able to use it in a device such as a tank, notably in a fluidized bed or in aqueous or solvent dispersion.

The device in the form of a tank, notably in a fluidized bed, can be open or closed.

Optionally, the matrix resin also comprises carbon fillers, particularly carbon black or carbon nanofillers, preferably chosen from among carbon nanofillers, particularly graphene and/or carbon nanotubes and/or carbon nanofibrils or their mixtures. These fillers allow for the conduction of electricity and heat and therefore facilitate the melting of the matrix when heated.

Optionally, said reactive thermoplastic polymer comprises at least one additive, notably chosen from among a catalyst, an antioxidant, a thermal stabilizer, a UV stabilizer, a light stabilizer, a lubricant, a filler, a plasticizer, a flame retardant, a nucleating agent, a dye, an electrically conductive agent, a thermal conductive agent, or a mixture thereof.

Advantageously, said additive is chosen from among a flame retardant, an electrically conductive agent, and a thermal conductive agent.

Said flame retardants can be halogen-free flame retardants, such as those described in US 2008/0274355, and notably a metal salt chosen from among a metal salt of phosphinic acid, a metal salt of diphosphinic acid, a polymer containing at least one metal salt of phosphinic acid, a polymer containing at least one metal salt of diphosphinic acid or red phosphorus, antimony oxide, zinc oxide, iron oxide, magnesium oxide, or metal borates such as zinc borate or even melamine pyrophosphates and melamine cyanurates. They can also be halogenated flame retardants such as brominated or polybrominated polystyrene, brominated polycarbonate, or brominated phenol.

Advantageously, the said reactive thermoplastic polymer is a polyamide and is chosen from among aliphatic polyamides, cycloaliphatic polyamides, and semi-aromatic polyamides (polyphthalamides).

Preferably,
the said aliphatic polyamide is chosen from among the polyamide 6 (PA-6), the polyamide 11 (PA-11), the polyamide 12 (PA-12), the polyamide 66 (PA-66), the polyamide 46 (PA-46), the polyamide 610 (PA-610), the polyamide 612 (PA-612), the polyamide 1010 (PA-1010), the polyamide 1012 (PA-1012), the polyamide 11/1010, and the polyamide 12/1010, or a mixture thereof or a copolyamide thereof, and polyetheramide or polyetheresteramide copolymers (PEBA) (or block copolymers with polyamide blocks and polyether blocks), preferably chosen from among the polyamide 6 (PA-6), the polyamide 11 (PA-11), the polyamide 12 (PA-12), the polyamide 66 (PA-66), the polyamide 46 (PA-46), the polyamide 610 (PA-610), the polyamide 612 (PA-612), the polyamide 1010 (PA-1010), the polyamide 1012 (PA-1012), the polyamide 11/1010, and the polyamide 12/1010, or a mixture thereof, and
the said semi-aromatic polyamide is a semi-aromatic polyamide, possibly modified by urea units, notably a PA MXD6 and a PA MXD10 or a semi-aromatic polyamide of formula X/YAr, such as described in EP1505099, notably a semi-aromatic polyamide of formula A/XT wherein A is chosen from among a motif obtained from at least one amino acid, a motif obtained from at least one lactam, and at least one motif corresponding to the formula (diamine in Ca). (diacid in Cb), with a representing the number of carbon atoms of the diamine and b representing the number of carbon atoms of the diacid, a and b each being between 4 and 36, advantageously between 9 and 18, the motif (diamine in Ca) being chosen from among linear or branched aliphatic diamines, cycloaliphatic diamines, and alkylaromatic diamines, and the motif (diacid in Cb) being chosen from among linear or branched aliphatic diacids, cycloaliphatic diacids, and aromatic diacids;

X·T designates a motif obtained from the polycondensation of a diamine in Cx and terephthalic acid, with x representing the number of carbon atoms of the diamine in Cx, x being between 6 and 36, advantageously between 9 and 18, notably a polyamide of formula A/6T, A/9T, A/10T, or A/11T, A being such as defined above, in particular a polyamide PA 6/6T, a PA 66/6T, a PA 61/6T, a PA MPMDT/6T, a PA PA11/10T, a PA 11/6T/10T, a PA MXDT/10T, a PA MPMDT/10T, a PA BACT/10T, a PA BACT/6T, a PA 11/BACT, a PA BACT/10T/6T, a PA 11/BACT/10T.

T corresponds to terephthalic acid, MXD corresponds to m-xylylene diamine, MPMD corresponds to methylpentamethylene diamine, and BAC corresponds to 1,3-bis(aminomethyl)cyclohexane.

Preferably:
said aliphatic polyamide is chosen from among the polyamide 11 (PA-11), the polyamide 12 (PA-12), the polyamide 66 (PA-66), the polyamide 46 (PA-46), the polyamide 610 (PA-610), the polyamide 612 (PA-612), the polyamide 1010 (PA-1010), the polyamide 1012 (PA-1012), the polyamide 11/1010, and the polyamide 12/1010, or a mixture thereof or a copolyamide thereof, and polyetheramide or polyetheresteramide copolymers (PEBA) (or copolymer of polyamide block and polyether block), preferably chosen from among the polyamide 11 (PA-11), the polyamide 12 (PA-12), the polyamide 66 (PA-66), the polyamide 46 (PA-46), the polyamide 610 (PA-610), the polyamide 612 (PA-612), the polyamide 1010 (PA-1010), the polyamide 1012 (PA-1012), the polyamide 11/1010, and the polyamide 12/1010, or a mixture thereof, and
said semi-aromatic polyamide is a semi-aromatic polyamide, possibly modified by urea units, notably a PA MXD6 and a PA MXD10 or a semi-aromatic polyamide of formula X/YAr, such as described in EP1505099, notably a semi-aromatic polyamide of formula A/XT wherein A is chosen from among a motif obtained from at least one amino acid, a motif obtained from at least one lactam, and at least one motif corresponding to the formula (diamine in Ca). (diacid in Cb), with a representing the number of carbon atoms of the diamine and b representing the number of carbon atoms of the diacid, a and b each being between 4 and 36, advantageously between 9 and 18, the motif (diamine in Ca) being chosen from among linear or branched aliphatic diamines, cycloaliphatic diamines, and alkylaromatic diamines, and the motif (diacid in Cb) being chosen from among linear or branched aliphatic diacids, cycloaliphatic diacids, and aromatic diacids;
X·T designates a motif obtained from the polycondensation of a diamine in Cx and terephthalic acid, with x representing the number of carbon atoms of the diamine in Cx, x being between 6 and 36, advantageously between 9 and 18, notably a polyamide of formula A/6T, A/9T, A/10T, or A/11T, A being such as defined above, in particular a polyamide PA 6/6T, a PA 66/6T, a PA 61/6T, a PA MPMDT/6T, a PA PA11/10T, a PA 11/6T/10T, a PA MXDT/10T, a PA MPMDT/10T, a PA BACT/10T, a PA BACT/6T, a PA 11/BACT, a PA BACT/10T/6T, a PA 11/BACT/10T.

T corresponds to terephthalic acid, MXD corresponds to m-xylylene diamine, MPMD corresponds to methylpentamethylene diamine, and BAC corresponds to 1,3-bis(aminomethyl)cyclohexane.

Preferably, the said polyamide is a semi-aromatic polyamide chosen from among a PA MPMDT/6T, a PA PA11/10T, a PA 11/BACT, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/10T, a PA 11/BACT/10T, a PA 11/MXDT/10T.

Preferably, the said polyamide is an aliphatic polyamide PA11 or PA12, preferably PA11.

According to one alternative, the polyamide is a polyetheramide or polyetheresteramide copolymer (PEBA) (or copolymer of polyamide block and polyether block). The polyamide blocks of these copolymers can be chosen from among polyamide 6, polyamide 11, polyamide 6.10, polyamide 6.12, polyamide 10.10, polyamide 10.12, polyamide 10.14, polyamide 12, and their combinations. The polyether blocks of these copolymers can be chosen from among PEG (polyethylene glycol), PPG (polypropylene glycol), PO3G (polytrimethylene glycol), PTMG (polytetramethylene glycol or polytetrahydrofuran), and their combinations. Such copolymers can be prepared according to one of the patent applications FR2846332 in the name of ATOFINA or EP1482011 in the name of UBE INDUSTRIE

Preferably, the reactive thermoplastic polymer is an amorphous polyamide or a semi-crystalline polyamide presenting an absolute value of fusion enthalpy in the component (C1) before overmolding less than 12 J/g of matrix resin, preferably less than 8 J/g of matrix resin, preferably less than 5 J/g of matrix resin, calculated according to the equation (1).

$$\vert \underline{Fusion enthalph in component ( C 1 )} \vert = \underline{area under melting peak - area under crystallization peak} \qquad Equation ( 1 )$$

the measurement of enthalpy being performed by differential scanning calorimetry (DSC) according to the ISO 11357-3 standard of 2013, with the melting and crystallization peaks being the first heating peaks at a rate of 20 K/min. In an advantageous manner, the composite obtained with such a matrix allows for even more improved adhesion to be obtained with the overmolding matrix, notably resulting in an even greater peel strength. It should be understood that the component (C1) is preferably obtained by implementing a matrix resin composition in which the at least one polyamide is an amorphous or semi-crystalline polyamide with an absolute value of fusion enthalpy in the component (C1) before overmolding less than 12 J/g of matrix resin, preferably less than 8 J/g, preferably less than 5 J/g.

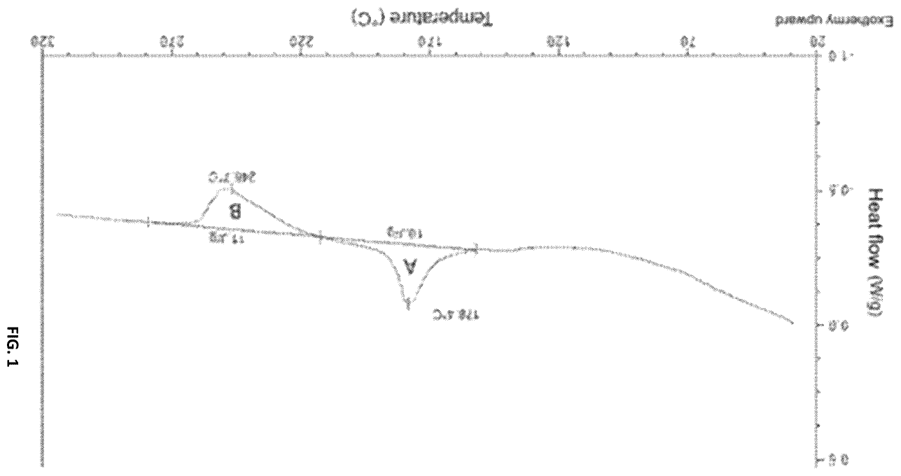

The following information allows to understand how the fusion enthalpy measurement is realized from the component (C1). It should be understood that during the DSC analysis of the component (C1), and notably during the first heating, crystals initially not present in the component (C1) may be formed during the first heating cycle, and the formation of these crystals, not initially present in the component (C1), will increase the measured fusion enthalpy in this same first heating. In order to determine the actual fusion enthalpy of the component (C1), it is therefore necessary to subtract from the area of the first heating fusion enthalpy peak (peak B in FIG. 1) the area of the first heating crystallization enthalpy peak (peak A in FIG. 1) if present. It is also agreed that this actual fusion enthalpy of the component (C1) is noted in absolute value. It is also agreed that the first heating crystallization enthalpy can be zero; if it is zero, then the actual fusion enthalpy of the component (C1) is equal to the first heating fusion enthalpy.

The actual fusion enthalpy thus measured and calculated is then corrected relative to the mass rate of matrix resin (and any fusible fillers of the matrix resin) in the component (C1) and reported to the mass of matrix resin in the component (C1), so the enthalpies mentioned above are therefore in J/g of matrix resin.

The mass rate of matrix resin can be obtained according to the ASTM D3171-22 standard by acid digestion of the resin and weighing before/after digestion.

### Fibrous Material

Preferably, the fibrous material consists of fibers, notably fibers of mineral, organic, or vegetable origin generally in the form of strands.

The fibers are preferably continuous fibers.

Among fibers of mineral origin, one can mention carbon fibers, glass fibers, basalt fibers, silica fibers, or silicon carbide fibers, for example.

Advantageously, these are carbon fibers the number of fibers per strand of which being greater than or equal to 12K (thus 12,000 filaments/strand), in particular is greater than or equal to 24K (24,000 filaments per strand) or glass fibers the weight of which is greater than or equal to 1200 Tex, particularly greater than or equal to 2400 Tex, notably greater than or equal to 2400 Tex.

Among fibers of vegetable origin, one can particularly mention fibers based on flax, hemp, lignin, bamboo, silk, notably spider silk, or sisal, cellulosic fibers in particular, viscose. These fibers of vegetable origin can be used pure, treated, or coated with a coating layer, to facilitate adhesion and impregnation of the matrix resin composition.

Among fibers of organic origin, can be mentioned fibers of organic origin such as amorphous thermoplastic fibers with a glass transition temperature Tg higher than the Tg of the polymer of the matrix resin composition when the latter is amorphous or higher than the Tf of the polymer of the matrix resin composition when the latter is semi-crystalline and the Tg of which (in the case of an amorphous) or Tf (in the case of a semi-crystalline) is higher than the injection temperature of the overmolding resin composition, or semi-crystalline thermoplastic fibers with a fusion temperature Tf higher than the Tg of the polymer of the matrix resin composition when the latter is amorphous or higher than the Tf of the polymer of the matrix resin composition and the Tg of which (in the case of an amorphous) or Tf (in the case of a semi-crystalline) is higher than the injection temperature of the overmolding resin composition, or a mixture of two or more of said fibers, preferably a mixture of carbon, glass, or silicon carbide fibers, in particular carbon fibers.

Preferably, the fibers are mineral fibers, notably a mixture of carbon, glass, or silicon carbide fibers, in particular carbon fibers.

The fibrous material can also be a fabric, braided or woven with fibers.

It can also correspond to fibers with holding threads.

These constituent fibers can be used alone or in mixtures. Thus, organic fibers can be mixed with mineral fibers to be impregnated with thermoplastic polymer, optionally with a chain extender, and form the impregnated fibrous material.

The strands of organic fibers can have several weights. They can also present several geometries. The fibers can present in the form of short fibers, which then compose felts or non-wovens that can be in the form of strips, mats, or pieces, or in the form of continuous fibers, which compose 2D fabrics, braids, or unidirectional (UD) fiber strands or non-wovens. The constituent fibers of the fibrous material can also present in the form of a mixture of these reinforcing fibers of different geometries. Preferably, the fibers are continuous.

Preferably, the fibrous material is constituted of continuous carbon, glass, or silicon carbide fibers or their mixture, in particular carbon fibers. It is used in the form of a strand or several strands.

In one embodiment, the matrix resin composition is distributed in a manner as homogeneous as possible within the fibers in order to obtain a minimum of porosities, in other words, a minimum of voids between the fibers. Indeed, the presence of porosities in this type of material can act as points of stress concentration, during mechanical tensile stress for example, and which then form points of initiation of rupture of the impregnated fibrous material and mechanically weaken it. A homogeneous distribution of the matrix resin composition therefore improves the mechanical strength and homogeneity of the composite material (component (C1)) formed from these impregnated fibrous materials.

The fiber content in the component (C1) is preferably between 40 and 65% by volume, preferably between 40 and 60% by volume, notably between 50 and 60% by volume.

The impregnation rate measurement can be performed by image analysis (using a microscope or camera or digital camera, notably), of a cross-section of the component (C1), by dividing the surface of the component (C1) impregnated by the matrix resin composition by the total surface of the product (impregnated surface comprising the matrix resin and the fibers, plus the surface of the porosities). In order to obtain a good quality image, it is preferable to embed the component (C1) cut in its transverse direction in a standard cold polymerizing polishing resin and polish with a standard protocol allowing to observe the sample under a microscope magnification of at least 6×.

Advantageously, the porosity rate of said impregnated fibrous material (the component (C1)) is less than 10%, notably less than 5%, in particular less than 2%.

It should be noted that a zero porosity rate is difficult to achieve (or measure) and that consequently, advantageously the porosity rate is greater than 0% but less than the rates mentioned above.

The porosity rate corresponds to the closed porosity rate and can be determined either by electron microscopy or as being the relative difference between the theoretical density and the experimental density of said impregnated fibrous material such as described in the examples section of the present invention.

The component (C1) can be obtained by any method known to those skilled in the art from the fibrous material and notably, for example, by coating on a fluidized bed, impregnation in aqueous or solvent dispersion of polymer powder, extrusion in a polymer melt (or melt route), dry powder sprinkling excluding voluntary electrostatic powdering.

In a particularly preferred manner, the component (C1) of the invention can be obtained according to the method described in WO2018/234436 and in a particularly preferred manner the fluidized bed method described on pages 15 to 21 of WO2018/234436.

### Overmolding Resin Composition

The overmolding resin composition according to the present invention comprises at least one polymer chosen from among the polymers used in the matrix resin.

Preferably, the polymer of the overmolding resin is identical to or different from the polymer of the matrix resin. Preferably, the polymer of the overmolding resin composition and that of the matrix resin composition are of the same chemical nature (notably functional group) and have the same physical properties.

Preferably, the overmolding resin composition according to the present invention comprises at least one polymer chosen from among polyamides, or polyetheramide or polyetheresteramide copolymers.

The polyamides are preferably as defined above for the matrix resin.

When the overmolding resin composition comprises at least one polyamide, it can be identical to or different from that of the matrix resin composition.

Preferably, the polymer of the overmolding resin composition and that of the matrix resin composition are of the same chemical nature (notably functional group) and have the same physical properties.

Preferably, the polymer of the overmolding resin composition and that of the matrix resin composition are identical.

In a particularly preferred manner:
the matrix resin comprises an aliphatic polyamide, preferably PA11 or PA12, for example, PA11, and the overmolding resin a PEBA; or
the matrix resin comprises an aliphatic polyamide, preferably PA11 or PA12, for example, PA11, and the overmolding resin an aliphatic polyamide, preferably PA11 or PA12, preferably PA11; or
the matrix resin comprises an aliphatic polyamide, preferably PA11 or PA12, for example, PA11, and the overmolding resin a semi-aromatic polyamide; or
the matrix resin comprises a semi-aromatic polyamide and the overmolding resin an aliphatic polyamide, preferably PA11 or PA12, for example, PA11.

Optionally, the overmolding resin composition comprises at least one additive, notably chosen from among a catalyst, an antioxidant, a thermal stabilizer, a UV stabilizer, a light stabilizer, a lubricant, a release agent, a filler, a plasticizer, a flame retardant, a nucleating agent, a chain extender, and a colorant, an electrically conductive agent, a thermal conductive agent, or a mixture thereof.

Advantageously, the said additive is chosen from among a thermal stabilizer, an antioxidant, a flame retardant, an electrically conductive agent, and a thermal conductive agent.

The surface resin composition may also comprise liquid crystal polymers or cyclized poly(butylene terephthalate), or mixtures containing them. These compounds notably allow to fluidify the matrix resin in the molten state, for better penetration into the core of the fibrous material.

The fillers can, for example, be chosen from among carbon fillers, in particular carbon black or carbon nanofillers, preferably chosen from among graphene, carbon nanotubes, carbon nanofibrils, or their mixtures. In a particularly preferred manner, the overmolding resin composition of the invention comprises from 0.01% to 2% by weight of filler, preferably from 0.01 to 0.5% by weight of filler relative to the total weight of the overmolding resin composition.

The overmolding resin composition may also comprise fibers, and more preferably short fibers, preferably short glass fibers or short carbon fibers.

The fibers preferably present a length between 2 and 13 mm, preferably from 3 to 8 mm before implementing the compositions.

The component (C2) can be in the form of foam, thus allowing for weight savings. The term “foam” or “polymer foam” means a biphasic material containing a continuous phase constituted of the polymer matrix and a continuous or discontinuous gaseous phase. A foam is said to have closed porosity when the polymer matrix is the only continuous phase of the system. The gas is present only in the discrete form of gas bubbles. Otherwise, in an open porosity foam, the gaseous phase and the polymer phase are continuous. The foam according to the invention can be prepared by mixing the overmolding resin with an expansion agent (and optionally one or more additives), then by performing a foaming step. The expansion agent can be a chemical or physical agent or can also consist of any type of hollow object or any type of expandable microsphere. By way of examples, but not limited to, the physical expansion agent can be nitrogen or carbon dioxide, or a hydrocarbon, chlorofluorocarbon, hydrochlorocarbon, hydrofluorocarbon or hydrochlorofluorocarbon (saturated or unsaturated) or a mixture thereof. The physical expansion agent can present in the form of gaseous, liquid, or supercritical form and in this case be converted into a gaseous phase during the foaming step. This same foaming step can be caused by a thermodynamic instability of the pressure and/or temperature jump type. For polyamides, notably the said foam presents a density less than or equal to 1000 kg/m3, preferably less than or equal to 800 kg/m3, preferably less than or equal to 600 kg/m3, preferably less than or equal to 500 kg/m3, preferably less than or equal to 400 kg/m3, more particularly preferable manner less than or equal to 300 kg/m3, ideally less than or equal to 200 kg/m3. The control of the foam density can be performed according to techniques known to those skilled in the art and notably by adapting the preparation method parameters. The density, or density, is measured according to ISO 1183-1 by the immersion method in water (23° C.).

Preferably, the thickness of the component (C1) is between 0.07 and 50 mm, preferably between 0.15 and 50 mm, even more preferably between 0.15 and 10 mm, for example between 0.15 and 4 mm, and the thickness of the component (C2) is between 0.5 and 50 mm, preferably between 0.5 and 10 mm, preferably between 0.5 and 5 mm, preferably between 0.15 and 2 mm.

In a particularly advantageous manner, the overmolded composite structure of the present invention does not comprise an adhesion primer between the components (C1) and (C2). Thus, and in a particularly advantageous manner, the component (C1) and the component (C2) in the overmolded composite structure are in direct contact without any intermediate layer. The cohesion between the components (C1) and (C2) is provided by the specific choice of the polyamide of the matrix resin composition defined above.

The absence of an adhesion primer allows for easier recycling of the overmolded composite structure. Recycling can notably be performed by grinding the overmolded composite structure to obtain shreds, heating the shreds to the melting point to form a molten mass; and extruding the molten mass in the form of pellets. Recycling can also be carried out by disassembling the two components (C1) and (C2) for example by heating or cooling then recycling or separate reuse of the components (C1) and (C2).

The expression “adhesion primer” means a compound that when applied to a support, in this case, the component (C1), and intended to receive a second support, in this case, the component (C2), allows to strengthen the bond between the two supports and therefore creates a chemical and/or physical bond between the two supports resulting in strong adhesion between said supports and thus allowing to solidify and therefore increase the adhesion of the component (C2) to the component (C1). Such adhesion primers are for example an epoxide, a combination of epoxides, an ethyl silicate, an aromatic or aliphatic polyurethane, and a mixture thereof, for example, an aromatic or aliphatic polyurethane, an epoxide, a mixture of aromatic or aliphatic polyurethane, and epoxide.

Preferably, the overmolded composite structure does not comprise an adhesion primer chosen from among an epoxide, a combination of epoxide, an ethyl silicate, an aromatic or aliphatic polyurethane, and a mixture thereof, for example, an aromatic or aliphatic polyurethane, an epoxide, a mixture of aromatic or aliphatic polyurethane, and epoxide.

### Method

The present application also relates to a method for manufacturing an overmolded composite structure according to the invention comprising a step of overmolding the component (C2) on at least a part of a surface(S) of the component (C1). The overmolding method is known to those skilled in the art. Thus, the second component (C2) is molded in a mold containing the prefabricated component (C1). The overmolding resin composition is introduced in the molten state.

Any overmolding technique known to those skilled in the art can be implemented. In a preferred manner, the overmolding of the method of the invention is done by injection (the overmolding resin composition is injected into the mold).

The component (C1) is manufactured before implementing the method of the invention by any technique known to those skilled in the art. A shape can be given to the component (C1) before the overmolding step.

In an advantageous manner, the method of the invention is devoid of a step of assembling the components (C1) and (C2) by means of adhesion primer.

In a preferred manner, the method of the invention does not require heating the component (C1) before the overmolding step. Preferably, the mold during the overmolding step is heated to a maximum temperature corresponding to the Tg of the matrix resin composition +40° C.

### Use

The present invention also relates to the use of the overmolded composite structures described above for the manufacture of parts notably in the fields of mechanics, aeronautics, nautical, automotive, oil and gas (particularly offshore, gas storage), energy, health and medical, sports and leisure, and electronics.

The present invention also relates to the use of a matrix resin composition such as defined above, for the preparation of an overmolded composite structure comprising a first component (C1) comprising at least one fibrous material and said matrix resin composition; and a second component (C2) comprising an overmolding resin composition, to improve adhesion between the component (C1) and the component (C2).

The present invention also relates to the use of a matrix resin composition such as defined above, for the preparation of an overmolded composite structure comprising a first component (C1) comprising at least one fibrous material and said matrix resin composition; and a second component (C2) comprising an overmolding resin composition, to obtain a peel strength measured according to a suitable protocol of ISO 4578:1997 (90° peel) greater than or equal to 50 N/cm, preferably greater than or equal to 70 N/cm and particularly preferred greater than or equal to 100 N/cm between the component (C1) and the component (C2).

The present invention also relates to the use of a matrix resin composition such as defined above, for the preparation of an overmolded composite structure comprising a first component (C1) comprising at least one fibrous material and said matrix resin composition; and a second component (C2) comprising an overmolding resin composition, not requiring an adhesion primer between the component (C1) and the component (C2).

The invention will be explained in more detail in the following examples.

### EXAMPLES

Unless otherwise stated, percentages are expressed by weight relative to the total weight of the composition.

### Example 1

### Preparation of the Components (C1) (Also Called Composites):

The composites are all unidirectional composites, meaning that the reinforcing fibers are all oriented in the same direction. The fibers used are constituted of carbon filaments with a unit diameter of 7 μm. These carbon fibers, initially constituted of 24,000 filaments each, are impregnated in a so-called fluidized bed powder method, as described in WO2018/234436, using powders, reactive or not, of polyamide 11 (PA11) powders of the same average particle size D50=108 μm. The powders are pre-additivated with 0.1% by weight of Monarch 800 carbon black (Cabot). The pre-impregnated obtained have an average width of 98 mm and an average thickness of 145 μm and have an average fiber content of 55% vol+/−1% as measured by ASTM D3171-22.

The pre-impregnated thus obtained are either used alone as the component C1 at the output of the impregnation process, or they are post-crystallized under vacuum, or finally, they are assembled and consolidated to make unidirectional composites by stacking several of these prepregs in automated fiber placement (AFP) followed by consolidation under a hot press. The consolidation time under the press at the holding temperature (beyond Tf, here at 210° C.) allows for adjusting the molar mass if a reactive resin is used. Here, we maintain 3 minutes at the consolidation hold at 210° C., always under a pressure of 10 bar. The cooling rates of the plates under the press are also varied (from very fast by air quenching the sample to very slow (5° C./min)) to adjust the crystallinity rate of the composite samples.

The samples will be named as follows:
T01: pre-impregnated from the fluidized bed impregnation method
T02: pre-impregnated from the fluidized bed impregnation process recrystallized for 3 hours at 130° C. under vacuum
P31: pre-impregnated T01assembled and consolidated 3 min under press and cooled by air quenching
P32: pre-impregnated T01assembled and consolidated for 3 minutes under a press and slowly cooled at 5° C./min

The plates thus obtained have a final thickness of 1.1 mm on average.

The composites integrated into the overmolding mold are pre-cut to the format 98×98 mm² and dried for 24 h under vacuum at 80° C.

Before being integrated into the overmolding mold, a 7 mm wide composite strip on the edge of the composite is covered with polyimide adhesive film, to initiate a peel start after overmolding.

### Injection Polymers and Overmolding Method:

The polymer used for performing the injection is polyamide 11 of grade BESNO TL. The injection is performed by use of a vertical press and a mold with dimensions 100×100×2 mm³ of cavity volume and a central point injection. The PA11 is injected using a barrel temperature of 290° C., a mold temperature of 80° C. (about 100° C. below the melting point of the polyamide 11 used to make the composite (matrix resin) or for injection). The holding pressure for these tests is 60% of the switch pressure and a holding time of 15 s.

### Characterization of Composites Before Overmolding:

Measurement of fiber content according to ASTM D3171-22: 55% vol+/−1% vol Measurement of the fusion enthalpy of the matrix resin in DSC (ISO 11357-3:2013)

Measurement of molecular weight Mn in GPC of the matrix resin

Measurement of the viscosity of the matrix resin as mentioned above

### Preparation of Peel Specimens and Peel Tests:

The overmolded plates obtained are then cut to extract peel specimens with dimensions 98×15 mm², cut in the longitudinal direction of the fibers (so 98 mm corresponds to the length of the specimen in the fiber direction).

The adhesive performance measurement was performed according to the 90° peel method adapted from ISO 4578:1997 described above. The setup used is that imposed by the pulley plate and is connected to a Criterion C42 dynamometer equipped with a suitable force cell. The test is performed at a speed of 50 mm/min, with a crosshead displacement of 50 mm. We analyze for each type of overmolded component 5 distinct specimens.

### Results

For the examples C001 to C004, the polyamide 11 powder used in the impregnation method to create the component (C1) (also called composite) is a PA11 reactive powder and presenting the following characteristics before impregnation: melt viscosity at 240° C. and at a shear rate of 1800 s^{-1=0.4} Pa·s, Mn=5400 g/mol (GPC molecular weight), IP=2.1. For the example C005, the polyamide 11 powder used in the impregnation method to create the component (C1) (also called composite) is a non-reactive PA11 powder and presenting the following characteristics before impregnation: melt viscosity at 240° C. and at a shear rate of 1800 s^{-1=0.4} Pa·s, Mn=6200 g/mol (GPC molecular weight), IP=2.1.

For the example C006, the polyamide 11 powder used in the impregnation method to create the component (C1) (also called composite) is a PA11 non reactive powder and presenting the following characteristics before impregnation: a melt viscosity at 240° C. and at a shear rate of 1800 s^{-1=1.3} Pa·s, Mn=10100 g/mol (GPC molecular weight), IP=2.1.

| | | | Volumetric fiber level | | |
|---|---|---|---|---|---|
| Mean composite | | Mass of matrix | in the composite | | |
| thickness before | Reactive to | resin before | before overmolding | | |
| overmolding (mm) | the resin | overmolding (% m) | (% vol) | Component C1 | Test |
| 0.141 | YES | 31.8 | 55.2 | T01 | C001 |
| 0.145 | YES | 31.2 | 55.7 | T02 | C002 |
| 1.109 | YES | 31.6 | 55.3 | P31 | C003 |
| 1.121 | YES | 31.3 | 55.7 | P324 | C004 |
| 0.142 | NO | 31.4 | 55.6 | T01 | C005 |
| | | | | | (comparative |
| 1.102 | NO | 32.1 | 54.8 | P31 | C006 |
| | | | | | (comparative) |

| | Composite | | | | Polymolecular | Molar mass of |
|---|---|---|---|---|---|---|
| | preheating | | | Fusion enthalpy | index of the | the matrix |
| | temperature | | Viscosity of the | of the matrix | matrix resin | resin before |
| | before | njection mold | matrix resin | resin before | before | overmolding |
| Peeling force | overmolding | temperature | (Pa · s)(240° | overmolding | overmolding | (Mn GPC · |
| (N/cm) | (° C.) | (° C.) | C./1800 s⁻¹) | (J/g of resin) | (GPC) | g/mol) |
| 142 | 80 | 80 | 0.6 | 4.0 | 2.1 | 7,000 |
| 125 | 80 | 80 | 0.6 | 53.5 | 2.1 | 7,000 |
| 103 | 80 | 80 | 1.6 | 5.0 | 2.2 | 11,100 |
| 64 | 80 | 80 | 82.0 | 56.5 | 3.7 | 29,600 |
| 107 | 80 | 80 | 0.4 | 3.8 | 2.1 | 6,400 |
| 77 | 80 | 80 | 1.3 | 5.6 | 2.2 | 10,300 |

All composite data are measured begore preheating the composite.

The above examples show that, when comparing C001 with C005, but also C003 with C006, a higher peel strength is obtained when the matrix resin of the composite before overmolding is reactive. Similarly, it is noted by comparing tests C001 to C003 and C004 that in the case of a reactive matrix resin of the composite before overmolding, higher peel strengths are achieved if the viscosity of the matrix resin before overmolding is low, and the molar masses are low.

### Example 2

### Preparation of the Components (C1) (Also Called Composites):

The composites are all unidirectional composites, meaning that the reinforcing fibers are all oriented in the same direction. The fibers used are constituted of carbon filaments with a unit diameter of 7 μm. These carbon fibers, initially constituted of 24,000 filaments each, are impregnated in a so-called fluidized bed powder method, as described in WO2018/234436, using polyamide 11 (PA11) powders of the same average particle size D50=108 μm. The powders are pre-additivated with 0.1% by weight of Monarch 800 carbon black (Cabot).

The pre-impregnated obtained (or the components C1) have an average width of 98 mm and an average thickness of 145 μm and have an average fiber content of 55% vol+/−1% such as measured by ASTM D3171-22.

### Overmolding Method

The components (C1) obtained are cut to obtain specimens presenting the following dimensions (L×W×H): 125×25×1.5 mm.

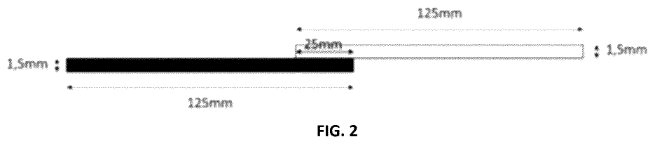

The specimens are placed in a mold allowing to accommodate the specimens on one side and injecting the polymer of the overmolding composition on the other in order to generate a contact area between the composite substrate and the overmolded surface composition 25×25 mm. The representative diagram of these specimens is presented in FIG. 2 (in black the composite (C1) and in white the overmolded component (C2)).

### Storage and Analysis Conditions

The overmolded specimens are conditioned for a minimum of 240 h at 23° C. in a sealed bag upon exit from overmolding. After opening the bag and until testing, the specimens are placed in a desiccator at room temperature

The offset support tensile tests were performed according to conditions approaching the NF EN 1465 (2009) standard, the details of which follow:
Initial distance between jaws: 115 mm
Test speed: 1.3 mm/min
Test temperature: 23° C.+/−2° C.
Relative humidity: 50%+/−10%

A rupture force is measured as soon as the composite/polymer interface is broken.

The device used in the tests is a ZWICK 1455 dynamometer equipped with a 20 kN cell.

The area of the composite (C1) that will then be in contact with the overmolding composition (C2) can be preheated, before the overmolding step.

Overmolding is performed at a temperature of 260° C.

The matrices implemented in the components (C1) are as follows:
S1: The PA11 powder used in the impregnation method to create the component (C1) is a reactive PA11 powder and presenting the following characteristics before impregnation: melt viscosity at 240° C. and at a shear rate of 1800 s^{-1=0.7} Pa·s, Mn=7500 g/mol (GPC molecular weight), IP=2.3
S2: The PA11 powder used in the impregnation method to create the component (C1) is a non-reactive PA11 powder, and presenting the following characteristics before impregnation: melt viscosity at 240° C. and at a shear rate of 1800 s^{-1=0.4} Pa·s, Mn=6200 g/mol (GPC molecular weight), IP=2.1
S3: The PA11 powder used in the impregnation method to create the component (C1) is a reactive PA11 powder, and presenting the following characteristics before impregnation: melt viscosity at 240° C. and at a shear rate of 1800 s^{-1=0.4} Pa·s, Mn=5400 g/mol (GPC molecular weight), IP=2.1
S4 (comparative): The PA11 powder used in the impregnation method to create the component (C1) is a non-reactive PA11 powder, and presenting the following characteristics before impregnation: melt viscosity at 240° C. and at a shear rate of 1800 s⁻¹⁼²⁰⁵ Pa·s, Mn=39500 g/mol (GPC molecular weight), IP=2.1

The results obtained are presented in the tables below:

TABLE 2

| | Overmolding | Component | | |
|---|---|---|---|---|
| Test | matrix | matrix (C1) | Preheating | Force (N) |
| E1 | Rilsan ® PA11 | S1 | None | 1416 |
| | BZM8 | | 100° C. | 1654 |
| | | | 150° C. | 3011 |
| E2 | | S3 | None | 2109 |
| | | | 100° C. | 3011 |
| | | | 150° C. | 3808 |
| E3 | Rilsan ® PA11 | S1 | None | 3099 |
| | BZM30 | | 100° C. | 3346 |
| | | | 150° C. | 3299 |
| E4 | | S3 | None | 5712 |
| | | | 100° C. | 5932 |
| | | | 150° C. | 6150 |
| E5 | Pebax ® Rnew ® | S3 | None | 990 |
| | 55R53 | | 100° C. | 1026 |
| | | | 150° C. | 1165 |
| E6 | Rilsan ® PA11 | S1 | None | 4970 |
| | BSR30 | | 100° C. | 4947 |
| | | | 150° C. | 4820 |
| E7 | | S3 | None | 9233 |
| | | | 100° C. | 9277 |
| | | | 150° C. | 9848 |

TABLE 3

| | | Substrate | | |
|---|---|---|---|---|
| Comparative | Overmolding | (component | | Force |
| test | matrix | (C1)) | Preheating | (N) |
| EC1 | Rilsan ® PA11 | S4 | None | 50 |
| | BZM8 | | 100° C. | 50 |
| | | | 150° C. | 1038 |
| EC2 | | S2 | None | 1287 |
| | | | 100° C. | 1555 |
| | | | 150° C. | 2604 |
| EC3 | Pebax ® PA11 | S4 | None | 2023 |
| | BZM30 | | 100° C. | 3001 |
| | | | 150° C. | 2949 |
| EC4 | | S2 | None | 3145 |
| | | | 100° C. | 3488 |
| | | | 150° C. | 3623 |
| EC5 | Pebax ® Rnew ® | S2 | None | 821 |
| | 55R53 | | 100° C. | 799 |
| | | | 150° C. | 876 |
| EC6 | | S4 | None | 386 |
| | | | 100° C. | 402 |
| | | | 150° C. | 780 |
| EC7 | | S4 | None | 50 |
| EC8 | Rilsan ® PA11 | S2 | None | 5024 |
| | BSR30 | | 100° C. | 5433 |
| | | | 150° C. | 6864 |

The tests show that the implementation of matrix resins according to the invention in the components C1 for the preparation of overmolded composites allows to obtain good adhesion without requiring preheating of the components C1 before the overmolding step. The tests also show that with preheating of a component C1, adhesion is improved relative to an overmolded composite the matrix resin of which is different from that of the invention.

The comparative tests with S2 must be compared to the tests with S3 (equal viscosity). This comparison shows that the combination of molar mass and reactivity characteristics allow to improve the adhesion between the component (C1) and the overmolded component (C2).

1. An overmolded composite structure comprising:
i) a first component (C1) comprising at least one fibrous material and a matrix resin composition, said matrix resin composition comprising at least one reactive thermoplastic polymer, and possibly a chain extender and/or chain limiter and/or catalyst and/or one or more additives, the said thermoplastic polymer presenting a number average molecular weight Mn between 3,000 and 35,000 g/mol; and
ii) a second component (C2) comprising an overmolding resin composition,
the said first component (C1) comprising at least one surface(S) and the said component (C2) adhering to the said component (C1) on at least a part of the said surface(S).

2. The overmolded composite structure according to claim 1, wherein the said at least one reactive thermoplastic polymer is a polyamide, polycarbonate, or polymethacrylate.

3. The overmolded composite structure according to claim 1, wherein the said at least one reactive thermoplastic polymer is chosen from among:
an aliphatic polyamide chosen from among the polyamide 6 (PA-6), the polyamide11 (PA-11), the polyamide 12 (PA-12), the polyamide 66 (PA-66), the polyamide 46 (PA-46), the polyamide 610 (PA-610), the polyamide 612 (PA-612), the polyamide 1010 (PA-1010), the polyamide 1012 (PA-1012), the polyamide 11/1010, and the polyamide 12/1010, or a mixture thereof or a copolyamide thereof, and polyetheramide or polyetheresteramide copolymers (PEBA) (or copolymer of polyamide block and polyether block), or
a semi-aromatic polyamide, is a PA MXD6 and a PA MXD10 or a semi-aromatic polyamide of formula A/XT wherein A is chosen from among a motif obtained from at least one amino acid, a motif obtained from at least one lactam, and at least one motif corresponding to the formula (diamine in Ca)·(diacid in Cb), with a representing the number of carbon atoms of the diamine and b representing the number of carbon atoms of the diacid, a and b each being between 4 and 36, the motif (diamine in Ca) being chosen from among linear or branched aliphatic diamines, cycloaliphatic diamines, and alkylaromatic diamines, and the motif (diacid in Cb) being chosen from among linear or branched aliphatic diacids, the cycloaliphatic diacids and aromatic diacids; X·T designates a motif obtained from the polycondensation of a diamine in Cx and terephthalic acid, with x representing the number of carbon atoms of the diamine in Cx, x being between 6 and 36; T corresponds to terephthalic acid, MXD corresponds to m-xylylene diamine, MPMD corresponds to methylpentamethylene diamine, and BAC corresponds to 1,3-bis(aminomethyl)cyclohexane.

4. The overmolded composite structure according to claim 1, wherein the said at least one reactive thermoplastic polymer is chosen from among:
an aliphatic polyamide chosen from among the polyamide 11 (PA-11), the polyamide 12 (PA-12), the polyamide 66 (PA-66), the polyamide 46 (PA-46), the polyamide 610 (PA-610), the polyamide 612 (PA-612), the polyamide 1010 (PA-1010), the polyamide 1012 (PA-1012), the polyamide 11/1010, and the polyamide 12/1010, or a mixture thereof or a copolyamide thereof, and polyetheramide or polyetheresteramide copolymers (PEBA) (or block copolymers with polyamide blocks and polyether blocks), or
a semi-aromatic polyamide.

5. The overmolded composite structure according to claim 1, wherein the reactive thermoplastic polymer is a semi-aromatic polyamide chosen from among a PA MPMDT/6T, a PA PA11/10T, a PA 11/BACT, a PA 11/6T/10T, a PA MXDT/10T, a PA MPMDT/10T, a PA BACT/10T, a PA BACT/6T, a PA BACT/10T/6T, a PA 11/BACT/6T, a PA 11/MPMDT/10T, a PA 11/BACT/10T, a PA 11/MXDT/10T.

6. The overmolded composite structure according to claim 1, wherein the reactive thermoplastic polymer is PA11 or a PA12.

7. The overmolded composite structure according to claim 1, wherein the overmolding resin composition is identical to or different from the matrix resin.

8. The overmolded composite structure according to claim 1, wherein the fibrous material comprises continuous fibers selected from among:
mineral origin fibers;
plant origin fibers;
organic origin fibers.

9. The overmolded composite structure according to claim 1, wherein it does not comprise an adhesion primer between the components C1 and C2.

10. The overmolded composite structure according to claim 1, wherein the matrix resin composition does not comprise filler or comprises less than 2% by weight of filler, relative to the weight of the matrix resin composition.

11. The overmolded composite structure according to claim 1, wherein the reactive thermoplastic polymer presents a melt viscosity measured in capillary rheology, measured at Tf+50° C., Tf being the melting temperature of at least one polyamide, at a shear rate of 1800 s⁻¹ between 0.05 and 1000 Pa·s.

12. The overmolded composite structure according to claim 1, wherein the reactive thermoplastic polymer is an amorphous polyamide or a semi-crystalline polyamide presenting an absolute value of fusion enthalpy in the component (C1), before overmolding, less than 12 J/g of matrix resin, calculated according to the equation (1)
$$\vert \underline{Fusion enthalph in component ( C 1 )} \vert = \underline{area under melting peak - area under crystallization peak} \qquad Equation ( 1 )$$
the measurement of enthalpy being performed by differential scanning calorimetry (DSC) according to the ISO 11357-3 standard of 2013, with the melting and crystallization peaks being the first heating peaks at a rate of 20 K/min.

13. The overmolded composite structure according to claim 1, wherein:
the matrix resin comprises an aliphatic polyamide, and the overmolding resin a PEBA; or
the matrix resin comprises an aliphatic polyamide, and the overmolding resin an aliphatic polyamide; or
the matrix resin comprises an aliphatic polyamide, and the overmolding resin a semi-aromatic polyamide; or
the matrix resin comprises a semi-aromatic polyamide and the overmolding resin an aliphatic polyamide.

14. A method for manufacturing an overmolded composite structure according to claim 1, comprising a step of overmolding the component C2 on at least part of the surface S of the component C1.

15. The method according to claim 14, wherein the overmolding step is an injection overmolding step.

16. A method comprising manufacturing a part comprising the overmolded composite structures according to claim 1.

17. A method comprising preparing an overmolded composite structure from a matrix resin composition as defined in claim 1, the overmolded composite structure comprising a first component (C1) comprising at least one fibrous material and the said matrix resin composition; and a second component (C2) comprising an overmolding resin composition, to achieve a peel strength measured according to an adapted protocol of the ISO 4578:1997 standard (90° peel) greater than or equal to 50 N/cm between the component (C1) and the component (C2).
